(19) United States
(12) Patent Application Publication
(10) Pub. No.: US 2003/0080833 A1
(43) Pub. Date: May 1, 2003

(54) Microwave filter cavity with spurious mode suppression

(76) Inventors: Stephen Berry, San Ramon, CA (US); Slawomir J. Fiedziuszko, Palo Alto, CA (US)

Correspondence Address: Joyce Kosinski, Loral Space and Communications, Ltd., Suite 303, 655 Deep Valley Drive, Rolling Hills Estates, CA, 90274, US

(21) Appl. No.: 10/001,491

(22) Filed: Oct. 31, 2001

(51) Int. Cl. H01P 1/208

(52) U.S. Cl. 333/202; 333/228; 333/231

(57) ABSTRACT

A microwave filter cavity that exhibits spurious mode suppression. The microwave filter comprises a metal mode suppression tuning stub located in a replaceable iris plate that is used to suppress unwanted transverse magnetic (TM) modes of the filter cavity, The mode suppression stub is disposed normal to an end wall of the cavity. The mode suppression stub perturbs the E-field of transverse magnetic modes, while having negligible effect on desired transverse electric (TE) modes. The addition of the tuning stub has no effect on filter performance determined by transverse electric modes.

### BACKGROUND

The present invention relates generally to filters, and more particularly, to a microwave filter cavity that exhibits spurious mode suppression.

The assignee of the present invention manufactures and deploys satellites that orbit the earth and which carry communication equipment, including microwave filters, and the like. In the past, in order to provide a cavity filter having suppressed spurious modes, the conventional technique would be to re-design and re-machine the filter cavity. This is costly and time-consuming.

It would be desirable to have a technique the does not require re-design or re-machining of a filter cavity but which provides spurious mode suppression. It is therefore an objective of the present invention to provide a microwave filter cavity that exhibits spurious mode suppression.

### SUMMARY OF THE INVENTION

To meet the above and other objectives, the present invention provides for a microwave filter cavity having spurious mode suppression. The microwave filter comprises a metal mode suppression tuning stub located in a replaceable iris plate that is used to suppress unwanted transverse magnetic (TM) modes of the filter cavity. The mode suppression stub is disposed normal to an end wall (or a replaceable iris plate) which perturbs the E-field of transverse magnetic modes, while having negligible effect on desired transverse electric modes.

The present invention suppresses unwanted transverse magnetic (TM) modes of a filter cavity without re-design or re-machining of the filter cavity. Existing cavities may be used, where in the past dimensions of the cavity would have to change. The addition of the tuning stub has no effect on filter performance determined by transverse electric modes.

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which:

FIG. 1 illustrates a partially cutaway view of an exemplary microwave filter cavity in accordance with the principles of the present invention;

FIG. 2 is a plot of a magnitude of transmission coefficient (S21) versus frequency for a conventional microwave filter cavity; and

FIG. 3 is a plot of a magnitude of transmission coefficient (S21) versus frequency for the present microwave filter cavity,

### DETAILED DESCRIPTION

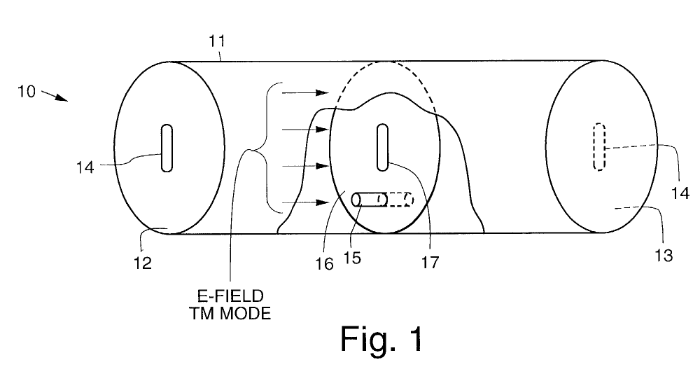

Referring to the drawing figures, FIG. 1 illustrates a partially cutaway view of an exemplary microwave filter cavity 10 in accordance with the principles of the present invention. The exemplary microwave filter cavity 10 comprises a housing 11 which may be cylindrical, and which has first and second end walls 12, 13. Each of the endwalls 12. 13 has a port 14 therein, such as an iris 14 or slot 14, for example that permits microwave energy to pass into and out of the filter cavity 10.

In accordance with the principles of the present invention a mode suppression stub 15 is disposed in a replaceable iris plate 16. The mode suppression stub 15 is a metal tuning stub 15 that is disposed normal to the replaceable iris plate 16. Alternatively, the mode suppression stub 15 may be disposed through and normal to one of the end walls 11, 12.

The mode suppression stub 15 perturbs the E-field of transverse magnetic (TM) modes that resonate within the filter cavity 10, while having negligible effect on desired transverse electric modes that resonate in the filter cavity 10. The mode suppression stub 15 suppresses unwanted transverse magnetic modes of the filter cavity 10 without re-design or re-machining of the filter cavity 10. Existing cavities 10 may be used by simply inserting the replaceable iris plate 16 between two portions 11a, 11b of the cavity 10. The addition of the mode suppression stub 15 has no effect on the performance of the filter cavity 10 determined by transverse electric modes.

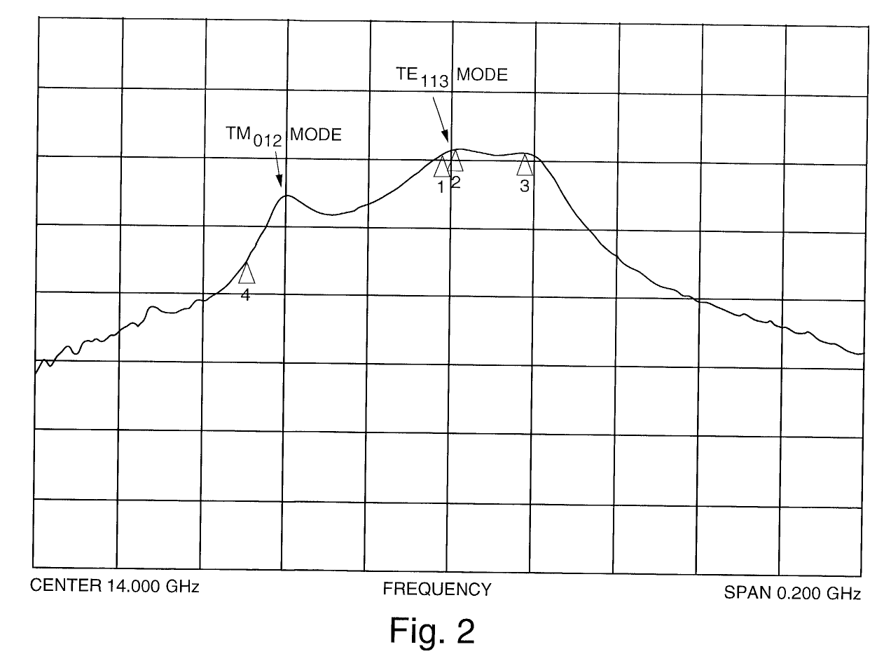

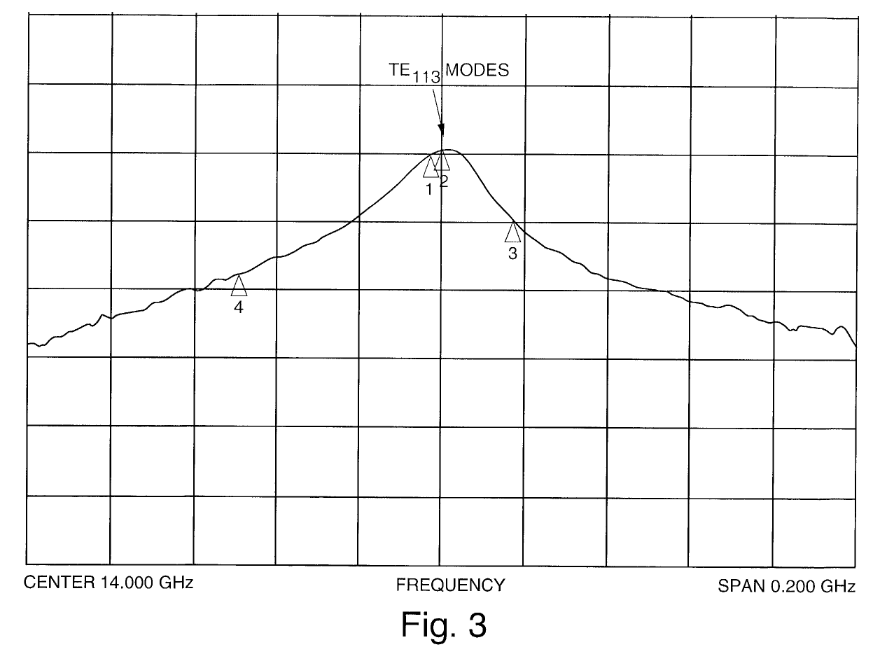

FIG. 2 is a plot of a magnitude of transmission coefficient (S21) versus frequency for a conventional microwave filter cavity. FIG. 3 is a plot of a magnitude of transmission coefficient (S21) versus frequency for the present microwave filter cavity. As should be clear from comparing FIGS. 2 and 3, mode suppression stub 15 suppresses unwanted transverse magnetic (TM) modes of a filter cavity 10.

Thus, a microwave filter cavity that exhibits spurious mode suppression using a mode suppression stub has been disclosed. It is to be understood that the described embodiment is merely illustrative of some of the many specific embodiments which represent applications of the principles of the present invention. Clearly, numerous and other arrangements can be readily devised by those skilled in the art without departing from the scope of the invention.

What is claimed is:

1. A microwave filter cavity comprising:
a housing having first and second end walls:
a port disposed in each of the endwalls; and
a mode suppression stub is disposed through one of the end walls that is disposed normal to the end wall,

2. The cavity recited in claim 1 wherein the housing is cylindrical.

3. The cavity recited in claim 1 wherein the port comprises an iris.

4. The cavity recited in claim 1 wherein the port comprises a slot.

5. The cavity recited in claim 1 wherein the mode suppression stub is disposed through a replaceable iris plate.

6. The cavity recited in claim 1 wherein the mode suppression stub comprises a metal tuning stub.

7. The cavity recited in claim 1 wherein the mode suppression stub perturbs E-fields of transverse magnetic modes that resonate within the filter cavity, while having negligible effect on desired transverse electric modes that resonate in the filter cavity.

8. The cavity recited in claim 1 wherein the mode suppression stub is disposed in a replaceable iris plate located between two portions of the cavity.

9. A microwave filter cavity comprising:
a housing having first and second end walls;
a port disposed in each of the endwalls;
an iris plate disposed in the cavity between the first and second end walls; and
a mode suppression stub is disposed through iris plate and normal to the iris plate,

10. The cavity recited in claim 9 wherein the housing is cylindrical.

11. The cavity recited in claim 9 wherein the port comprises an iris.

12. The cavity recited in claim 9 wherein the port comprises a slot.

13. The cavity recited in claim 9 wherein the iris plate is replaceable.

14. The cavity recited in claim 9 wherein the mode suppression stub comprises a metal tuning stub.

15. The cavity recited in claim 9 wherein the mode suppression stub perturbs E-fields of transverse magnetic modes that resonate within the filter cavity while having negligible effect on desired transverse electric modes that resonate in the filter cavity.
